(19) United States
(12) Patent Application Publication
(10) Pub. No.: US 2014/0195637 A1
(43) Pub. Date: Jul. 10, 2014

(54) ADAPTED PHYSICAL-LAYER TRANSMISSION PROPERTIES BASED ON PACKET STREAM

(71) Applicant: QUALCOMM INCORPORATED, San Diego, CA (US)

(72) Inventors: Ehab Tahir, Ontario (CA); John Fraser Chappel, Ontario (CA); Nikolai Kroupetski, Ontario (CA); Vladimir Vidovic, Ontario (CA); Hassan Afkhami, Ocala, FL (US); Purva R. Rajkotia, Orlando, FL (US); Manjunath Anandarama Krishnam, Gainesville, FL (US)

(73) Assignee: QUALCOMM INCORPORATED, San Diego, CA (US)

(21) Appl. No.: 13/738,607

(22) Filed: Jan. 10, 2013

(51) Int. Cl. H04L 29/06

(52) U.S. Cl. CPC H04L 65/4069
USPC 709/217

(57) ABSTRACT

A device may determine adapted physical layer transmission properties based upon characteristics of a packet stream to be transmitted via a communications channel. The physical layer transmission properties may comprise an adapted tone map that is associated with an aggressive physical layer throughput capability for UDP traffic, a conservative physical layer throughput capability for TCP traffic, or a dynamically adjusted physical layer throughput rate for mixed traffic. An indication regarding the adapted tone map may be included in a first message, a portion of a physical layer framing protocol, a physical layer control transmission (such as a frame control symbol), or other transmissions such that the receiving device can derive the adapted tone map without significant added overhead.

### BACKGROUND

Embodiments of the inventive subject matter generally relate to the field of network transmissions, and, more particularly, to adapted physical layer transmission properties based on packet stream characteristics.

A hybrid network (such as a Convergent Digital Home Network (CDHN), or P1905.1 network) is typically formed by interconnecting communication networks across different network technologies and communication media. The hybrid network may include hybrid communication devices (referred to herein as “hybrid devices”) that are often multi-interface and capable of operating across multiple networking technologies. A hybrid device (HD) may or may not have multiple interfaces but is considered a hybrid device if it is configured to use protocols associated with multi-interface devices in a hybrid network. For example, each hybrid device may support multiple interfaces using different network technologies (e.g., Ethernet, IEEE 802.11 WLAN, Coax, and powerline communications (PLC), etc.).

Communication technology is evolving to allow for better channel estimation and adaptation of transmissions over a communication channel. For example, in many technologies, such as powerline communications, a medium between a first device and a second device may support multi-carrier transmissions. Other medium and technologies may also use multi-carrier transmissions in which multiple frequencies are used over a communication channel.

### SUMMARY

Various embodiments are disclosed in which adapted physical layer transmission properties are based on characteristics of packet stream transmitted via a communication channel.

In one embodiment, a physical layer tone map for a communications channel of a hybrid network is determined based at least in part upon characteristics of a packet stream to be transmitted from a first device to a second device via a hybrid network. The characteristics of the packet stream may include an upper layer protocol field included in at least a first packet of the packet stream. The characteristics of the packet stream may be identified by the transport protocol, such as Transport Control Protocol (TCP) or Uniform Datagram Protocol (UDP). The first packet of the packet stream is transmitted to the second device using the determined physical layer tone map.

### BRIEF DESCRIPTION OF THE DRAWINGS

The present embodiments may be better understood, and numerous objects, features, and advantages made apparent to those skilled in the art by referencing the accompanying drawings.

FIG. 1 is an example system diagram illustrating a process for adjusting physical layer transmission properties based on characteristics of a packet stream.

FIG. 2 is a conceptual illustration of two tone maps associated with physical layer transmission properties.

FIG. 3 is a table illustrating hypothetical comparisons of two different tone maps.

FIG. 4 is a message flow diagram illustrating example communications between two devices in accordance with at least one embodiment of this disclosure.

FIG. 5 is a flow diagram illustrating example operations for determining adapted physical layer transmission properties.

FIG. 6 is a flow diagram illustrating example operations at a transmitter configured to determine an adapted tone map.

FIG. 7 is a flow diagram illustrating example operations at a receiver configured to receive data using an adapted tone map.

FIG. 8 is an example block diagram of one embodiment of an electronic device including a communication unit for use with adapted physical layer transmission properties.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

In some communication environments, a tone map defines physical layer transmission properties for each carrier used over a communication channel. Typically, a tone map is based upon channel quality and includes settings to maximize physical layer throughput. For example, a channel quality estimation process may be used to determine the maximum transmission rate possible for a communication channel. However, this approach may not be optimal for all types of packet streams because different packet streams may have different quality of service (QoS) or traffic shaping properties. It may be desirable to consider characteristics about a packet stream in the physical layer (PHY) rate selection process.

In accordance with this disclosure, adapted physical layer transmission properties for a communications channel are determined at least in part based upon characteristics of a packet stream to be transmitted from a transmitting device to a receiving device. For example, a packet stream may include Transport Control Protocol (TCP) packets, Uniform Datagram Protocol (UDP) packets, or a mix of TCP and UDP packets. The adapted physical layer transmission properties can be optimized based upon the type of packets included in a packet stream. In networking environments, different traffic types may utilize different transportation protocols. Some of the protocols are considered error-tolerant, while other protocols may have self-correction mechanisms to provide reliable delivery of the data. By using adapted physical layer transmission properties based upon the type of upper layer protocols (or type of application data), utilization of the physical layer media and performance of the networking environment can be improved.

In this disclosure, two example types of packet streams are described (TCP and UDP), however other classifications, types of data, or application layer information could be used in similar ways as described below for TCP and UDP packets. References to types of data or certain protocol should be understood to represent example characteristics of a packet stream. Other characteristics may be used to determine adapted physical layer transmission properties that are adapted for the particular characteristic. It is contemplated that characteristics may be signaled by upper layers of a protocol stack. However, in at least one embodiment, a MAC layer may inspect traffic associated with the packet stream to determine adapted physical layer transmission properties. In various embodiments, determinations of adapted physical layer transmission properties may be performed at a transmitting device (e.g. prior to transmission of the packet stream or after transmitting a portion of the packet stream) or at a receiving device (e.g. responsive to packet stream information provided by the transmitter or after receiving a portion of the packet stream). Similarly, a relay device or proxy may perform various operations described in this disclosure.

In accordance with at least one embodiment, a transmitting device may determine adapted physical layer transmission properties based upon characteristics of the packet stream to be transmitted via a communications channel. In some examples, an adapted tone map may be based upon an originally offered tone map or may be a new tone map generated by a transmitting device. An indication referencing the adapted tone map may be included in a first message, a portion of a physical layer framing protocol, a physical layer control transmission (such as a frame control symbol), or other transmissions. A receiver receiving such transmission or using such protocol may derive the adapted tone map and use the adapted tone map to receive the data. In some embodiments, two or more adapted tone maps may be preconfigured by the transmitter and receiver, such that the use of one of the preconfigured tone maps is selectable by a transmitting device based upon characteristics of the packet stream. In other embodiments, the tone map may be dynamically defined by a transmitter and receiver using analogous tone map controllers. Example techniques for deriving the adapted tone maps will be further described in the Figures below.

In this disclosure, examples are provided based upon powerline communication technology. It should be understood that the techniques herein may apply to other technologies that use multi-carrier transmissions over a communications channel between a first device and a second device. Although examples in this disclosure refer to tone maps and powerline communications, the scope of this disclosure should not be limited as such. Rather, the use of this disclosure may be used with adjusting a variety of physical layer transmission properties in a variety of communication technologies. The terms channel estimation, channel adaptation information, tone map, etc., while common terminology to persons of skill in the art of powerline communication technology, may have analogous terms of similar meaning in other communications technologies.

Various embodiments described herein may relate to hybrid devices operable in a hybrid network. A hybrid device described in this disclosure may be IEEE 1905.1 compliant. IEEE P1905.1 draft standard defines an abstraction layer (AL) for multiple home network technologies that provides a common interface to several popular network technologies: IEEE 1901 over power lines, IEEE 802.11 for wireless, Ethernet over twisted pair cable and MoCA 1.1 over coax. In this disclosure, a hybrid device is considered P1905.1 compliant if it includes the IEEE P1905.1 abstraction layer and associated protocols. The abstraction layer typically has a unique medium access control (MAC) address that is in addition to the interface layer (IL) MAC addresses associated with each interface of the hybrid device. Some embodiments described herein may be performed at an abstraction layer or interface layer of the MAC protocol layer.

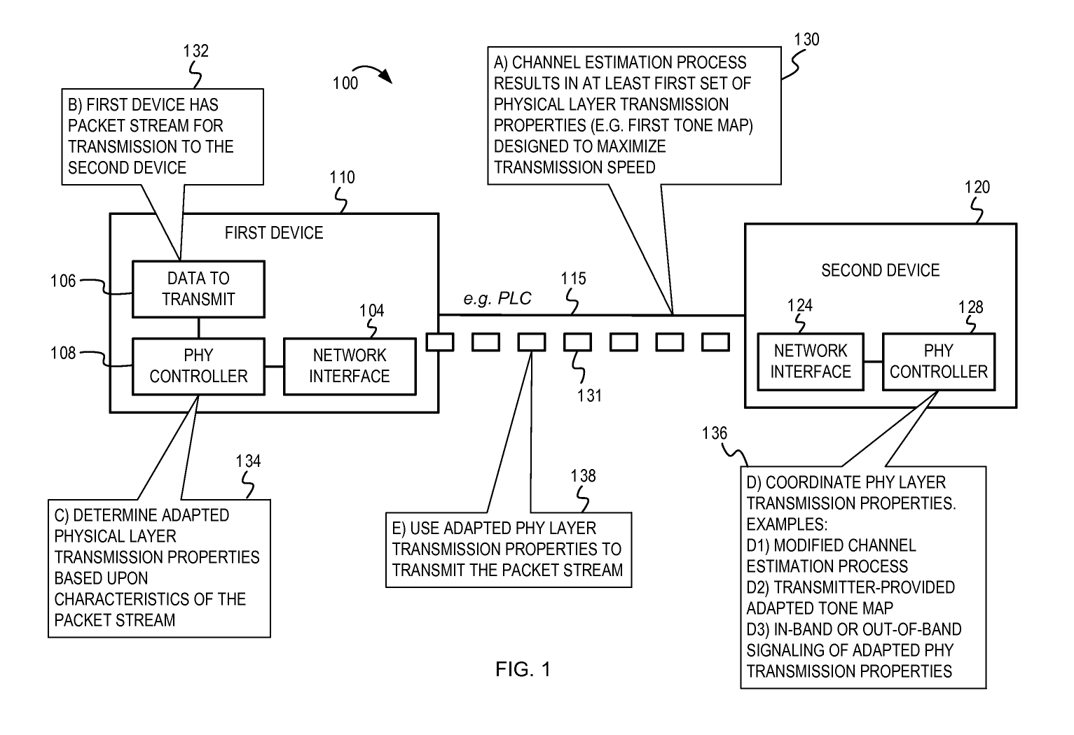

FIG. 1 is an example system diagram illustrating the use of adapted physical layer transmission properties based characteristics of a packet stream. In FIG. 1, a first device 110 is communicatively coupled to a network 115 using a network interface 104. In the example system 100 of FIG. 1, the network 115 is based upon powerline communication (PLC) and the physical layer involves a power line transmission medium. Also coupled to the network 115 is a second device 120. The first device 110 has data 106 that is queued for transmission to the second device 120. The first device 110 also has a physical layer controller 108. It should be noted that in some implementations, the physical layer controller 108 may be included in the network interface 104 or integrated with the network interface 104 as an integrated apparatus. Similar to the first device 110, the second device 120 includes a network interface 124 and corresponding physical layer controller 128. The physical layer controllers 108, 128 provides configuration of the network interfaces 104, 124, respectively. The configuration of network interfaces includes setting physical layer transmission properties associated with transmissions via a communications channel. The physical layer transmission properties may include settings for modulation, carrier usage, forward error control, guard interval spacing, frequency or time division multiplexing, etc. A communication channel, such as a communication channel via network 115 between the first device 110 and the second device 120, may have a variety of configurable physical layer transmission properties. The communication channel may include the use of orthogonal frequency division multiplexing or other techniques which allow for the combination of multiple carriers (i.e. frequencies) over the same communication channel.

At stage A (referenced at 130), a channel estimation process is performed. Typically a channel estimation process is used to determine the quality associated with each carrier (i.e. frequency) over the communications channel. In a typical channel estimation process, a transmitting device sends a signal that can be detected and measured by a receiving device. The receiving device analyzes the quality characteristics of the received signal to determine physical layer transmission properties for each carrier (in the form of a tone map). Upon completion of channel estimation processes, the receiving device may send a tone map (which may also be referred to as “channel adaptation information”) back to the transmitter. The tone map includes transmission properties (e.g. modulation, coding rate, error correction, etc.) for one or more carriers used in the communications channel. Typically the tone map is assigned to provide the greatest throughput possible by the communications channel.

A powerline communications channel between any two links has a different amplitude and phase response. Therefore, adapting the transmission properties for each carrier may result in a higher data rate. Some carriers may be deselected (e.g. masked) for use on the communications channel, while other carriers may utilize higher or lower modulation and data rates depending on the quality associated with each carrier. By turning off impaired frequencies, the bit error rates may be decreased on neighboring frequencies. On the remaining frequencies, selections regarding modulation, coding rate, and error correction for each carrier may result in a highly optimized link throughput. Channel quality is estimated at regular intervals for each carrier and a tone map is used to define which carriers are used to transmit data, as well as the type of modulation and error correction coding to be used. In traditional systems, the tone map is communicated from the receiving device to the transmitting device. In some variations, a receiving device may generate multiple tone maps to be used at different periods of time in the time domain of the communication channel. For example a first tone map may be assigned for a downward portion of a power cycle, and a second tone map may be used during the peak portion of the power cycle. The different tone maps may be provided by the receiving device to instruct the transmitting device which physical layer transmission properties to use during each period of the power cycle.

At stage B (referenced at 132), the first device 110 may have data 106 ready for transmission via network 115 to the second device 120. The data may come from upper layers of the first device 110 or may come from another network interface (not shown), wherein the first device is configured to bridge data from the other network interface to the network interface 104. In some implementations, the data may be temporarily stored in a transmission buffer (not shown) of the first device 110.

At stage C (referenced at 134), the physical layer controller 108 may determine an adapted tone map based upon characteristics of the packet stream. In some embodiments, the adapted tone map may be different from the tone map provided by the second device 120. For example, the adapted tone map may be associated with a slower data transmission rate than the tone map provided by the receiving second device 120. Depending upon the characteristics of the packet stream (such as a transport protocol, reliability of upper layers, or associated upper layer applications), a tone map may be adapted to better support the efficiency of the packet stream. In this disclosure, as an example, comparisons are drawn between the characteristics associated with UDP and TCP packet streams.

UDP is a transport protocol that does not define handshaking dialogues or requirements for providing reliability, ordering or data integrity. The UDP protocol aims to avoid processing overhead at the network layer. In some networking environments, UDP may be used for streaming media applications such as IPTV, VoIP, IP streaming, or gaming protocols. Therefore, when transmitting UDP packets over a communications channel, a transmitting device may increase PHY throughput (throughput being the PHY rate measured after accounting for PHY level errors) through use of a more aggressive than normal tone map (sending data at relatively high transmission speeds compared to the channel capacity while accepting a higher number of frame errors in transmission). In this disclosure, “aggressive” is used as a relative term defining a faster rate, higher throughput, and/or potentially higher error rate, when compared to a “conservative” tone map.

However, some consider UDP as an unreliable service since use of UDP assumes that error checking and correction is either not necessary or performed in the application layer (above UDP). In contrast, TCP provides reliable, ordered delivery of a packet stream of data. The TCP protocol was designed to mitigate or compensate for congestion in large scale networks. As such, TCP is commonly associated with services like World Wide Web, email, remote administration, and configuration applications. In mitigating or compensating for congestion, a TCP window size may decrease the number of TCP packets in the network, and the window size can be adjusted when necessary due to congestion or rate limiting. In networks operating on media susceptible to physical errors (such as wireless or powerline), the physical layer channel errors can result in dropped TCP packets, which can be mistaken for congestion on the network. TCP may then require retransmission of packets and/or modify the TCP layer throughput to accommodate for the physical layer congestion. Retransmission could result in lower TCP layer performance and thereby impact the application throughput. Therefore, for TCP transmissions, a more conservative tone map (to thus cause the transmitting device operate at relatively low transmission speeds compared to the channel capacity and, as a result, cause relatively few block errors) may be desirable.

In one embodiment, the adapted tone map may be based upon the quality of service (QoS) and traffic shaping requirements of the MAC data stream. In one example, the MAC data stream may be set with QoS and traffic shaping requirements set by a higher layer entity (e.g., a hybrid protocol stack abstraction layer, a network layer, etc.). In another example, the MAC data stream may have MAC protocol data units (PDUs) that can be analyzed to determine MAC layer packet classification. Inspecting the contents of the MAC PDU, or by signaling from a higher layer, a MAC layer can determine characteristics of the packet stream.

It should be understood that tone maps are just one form of physical layer transmission properties. At the physical layer, several physical layer transmission properties may be controlled to yield faster or slower transmission speeds or transmission reliability. For example, such physical layer transmission properties may include the PHY rate, transmission size, transmission rate, Channel Access Priority, Guard Interval, FEC Encode rate, etc. For data streams requiring guaranteed, low latency throughput (e.g., some TCP applications) a conservative PHY rate could be defined in a conservative tone map so as to minimize the possibility of PHY layer retransmissions. In contrast, the overall throughput of a best effort UDP stream could be improved by using a more aggressive PHY rate (defined in an aggressive tone map) having lower latency. Another physical layer transmission property that could be determined dependent upon the type of upper layer data is the transmission size. Limiting the maximum transmission size (controlling the transmission rate) may prevent bursty reception and reduce the probability of potential overflow in upstream devices. There may be many ways in which physical layer transmission properties are determined in dependence upon the type of data to be transmitted.

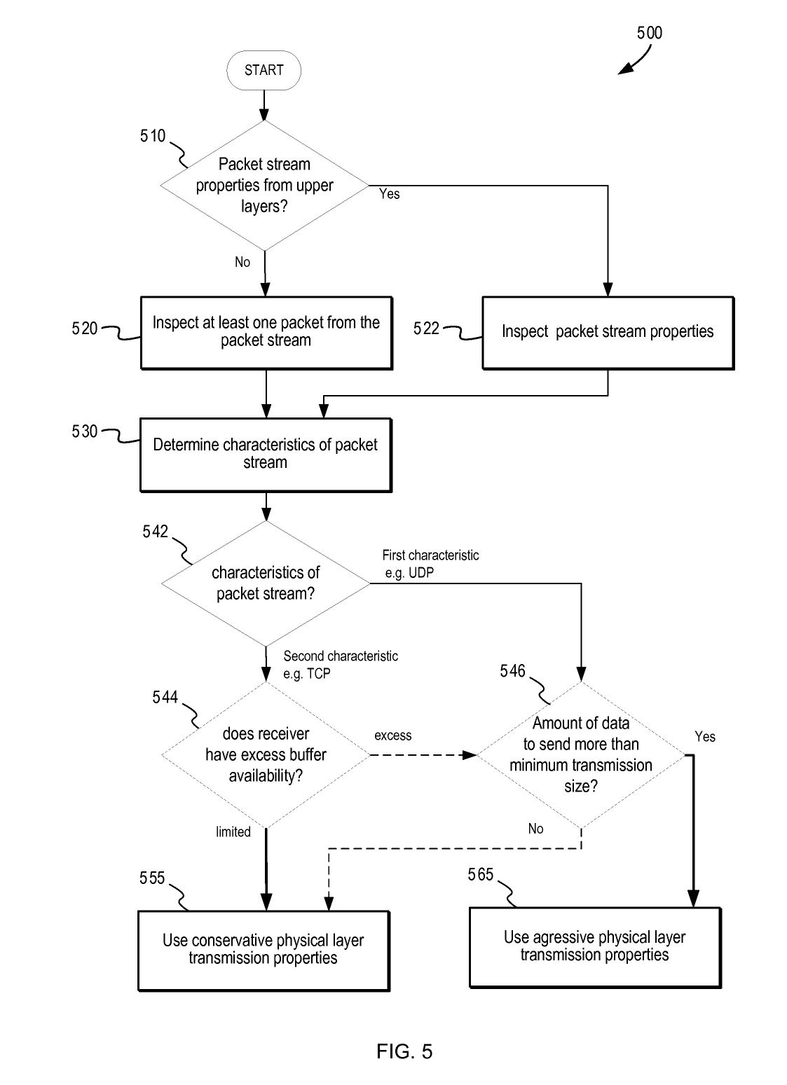

Also at stage C (referenced at 134), in addition to characteristics of the packet stream or alternatively, other factors may be used in determining the adapted tone map. For example, the adapted tone map may also be further modified based upon an amount of buffer available to buffer packets of different types of data. For example, if a limited buffer size is available for TCP packets, a conservative tone map may be selected so that retransmissions are avoided. If more buffer size is available (including for TCP traffic), the first device may adjust the conservative tone map to be more aggressive. Therefore, the adapted tone map may be selected in dependence on at least the type of data traffic, buffer size available, and channel quality estimation. The adapted tone map may be adjusted based upon medium utilization. For example, if medium utilization is low, the tone map may be adjusted to a conservative tone map. If medium utilization is above a threshold, the tone map may be adjusted to an aggressive tone map. Additionally, the adapted tone map may also be adjusted based on the amount of data in a transmit buffer. For example, if there is less data buffered for transmission than a minimum transmission size associated with an aggressive tone map (including for UDP traffic), than a conservative tone map may be used. Further examples of determining the adapted tone map are described in FIG. 5. It should be understood that physical layer transmission properties (associated with a variable adapted tone map) may be adjusted periodically or in response to changing conditions (such as changes in the type of data traffic, buffer availability, or channel quality).

At stage D (referenced at 136), the adapted tone map is coordinated between the physical layer controller 108 of the first device 110 and the physical layer controller 128 of the second device 120. In one embodiment, the transmitting device (e.g., the first device 110) determines the adapted tone map based on inspection of the packet stream prior to transmission. The first device 110 may use a variety of mechanisms to communicate information about the packet stream or the adapted tone map to the receiving device (e.g., the second device 120). In an alternative embodiment, the receiving device may determine the adapted tone map based on received packets representing a first portion of the packet stream. The receiving device may then determine the adapted tone map and communicate the adapted tone map to the transmitting device for use in subsequent packets representing a second portion of the packet stream. Several mechanisms are contemplated for coordination of the adapted tone map between the transmitting device and the receiving device.

At example stage D1 (referenced at 136), a mechanism for coordinating the adapted tone map between the first device 110 and second device 120 may involve the channel estimation process. For example, the channel estimation process may be modified so that the first device 110 may communicate information about the packet stream (such as packet stream characteristics, or an indication regarding relative aggressive or conservative communication channel requirements) to the second device 120. The second device 120 may utilize the information about the packet stream when generating one or more receiver-generated tone maps, which are subsequently provided to the first device 110.

As a further example of stage D1, a transmitting device receives at least a first packet of a packet stream to be transmitted to the destination device. Based upon the first packet (or a plurality of packets), the transmitting device can determine the type of data associated with the packet stream (e.g. TCP or UDP, or QoS settings, or traffic shaping parameters). The transmitting device can send an indication of the type of data (or the traffic shaping parameters) associated with the packet stream, to the receiving device as part of the channel estimation process. The receiving device may select the tone map based at least in part upon the type of data that the transmitting device has to send to the receiving device. Alternatively, the receiving device may send back multiple optional tone maps, including an aggressive tone map and a conservative tone map. In the example, where the transmitter has a mix of data types associated with a data stream, the receiver can optimize the tone map(s) based upon the mix of data types.

At example stage D2 (referenced at 136), another mechanism for coordinating the adapted tone map between the first device 110 and second device 120 may involve the first device 110 determining a transmitter-generated tone map based upon the characteristics of the packet stream. The transmitter-generated tone map may be communicated to the second device 120. In some example systems, communicating a full tone map may add a relatively large amount of overhead bandwidth. Therefore, in some implementations, rather than communicating a full transmitter-generated tone map, an indication regarding the transmitter-generated tone map may be communicated to the second device 120 to allow the second device 120 to derive the transmitter-generated tone map from the indication. For example, the indication may be associated with an adjustment factor, a predefined adaptation algorithm, an index to a tone map, indicia of the packet stream characteristics, or other indication which a receiving device may use to derive the same adapted tone map determined by the transmitting device.

As a further example of stage D2, a transmitting device may determine physical layer transmission properties (such as a transmitter-selected tone map) based upon the type of data to send from the transmitting device to the receiving device. The transmitter-selected tone map may be different from a receiver-provided tone map having a higher transmission speed previously determined based upon a channel estimation process compared to the transmitter-selected tone map. In some implementations, the transmitter-selected tone map may be a derated tone map which is based on an adjustment factor applied to the receiver-provided tone map. For example, a receiver-provided tone map may be used for the aggressive tone map (e.g. UDP packets), while a transmitter-selected tone map may be a level reduction applied to the receiver-provided tone map. The transmitter-selected tone map may be used for the conservative tone map (e.g. TCP packets). The level reduction may be a factor, such as an algorithmically calculated decrease in modulation, transmission rate, encoding, FEC, etc. The factor may be indicated back to the receiving device so that the receiving device can use the same algorithmic calculations to determine the transmitter-selected tone map based upon the receiver-provided tone map and the factor.

At stage D3 (referenced at 136), another mechanism for coordinating the adapted tone map between the first device 110 and second device 120 may involve communicating information about a dynamically adjusted tone map. The information about the dynamically adjusted tone map may be transmitted using in-band signaling or out-of-band signaling, between the first and second devices 110, 120. For example, a dynamically adjusted tone map may be based on adjustments to a previous tone map, the adjustments made periodically in response to changes in the characteristics of the packet stream. For example, as a mix of packets in a packet stream changes from 10% UDP+90% TCP to a mix of 30% UDP+70% TCP, an adjustment factor may modify the dynamically adjusted tone map by a degree of change. The adjustment factor may be indicated in either in-band or out-of-band communications between the transmitter and receiver. Examples of indications for adapted tone maps are described further in FIGS. 5-7.

Another example of an in-band communication for indicating changes to a dynamically adjusted tone map may be the use of feedback messages from a receiver to a transmitter. The feedback messages may be used to verify reception of transmitted MAC PDUs and also include an indicator associated with an adjustment factor, adaptation algorithm, index reference, or some other indicator used by the transmitter to derive the adapted tone map determined by the receiver. The receiver may monitor packets of the packet stream over a period of time and utilize a reverse feedback indicator to communicate changes to the existing tone map to derive the adapted tone map for subsequent packets. In this example, the adapted tone map may be dynamically adjusted periodically in response to changes in the characteristics of the packet stream.

At stage E (referenced at 138), the adapted tone map is used to transmit a plurality of packets 131 via the communications channel.

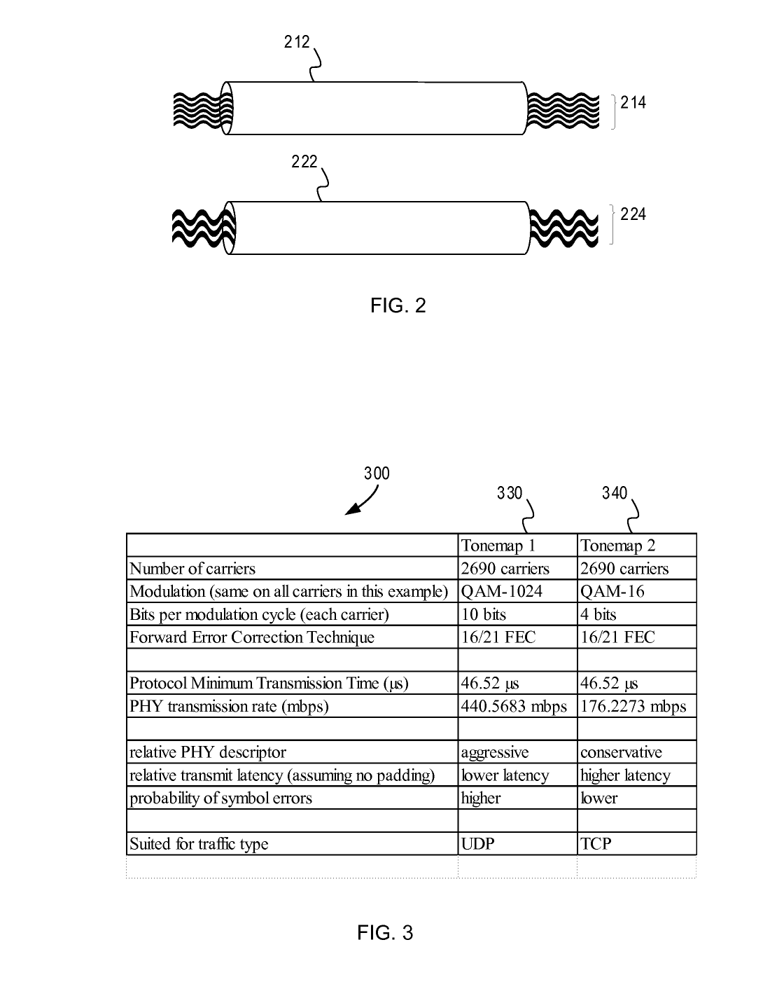

FIG. 2 is a conceptual illustration of two tone maps associated with physical layer transmission properties. Typically, tone maps are chosen to maximize data throughput by choosing the highest possible transmission properties that result in a tolerable amount of errors in a physical layer transmission. However, the different types of packet streams may benefit from using different types of tone maps.

In the conceptual illustration, a first example 212 is utilizing first tone map (such as an aggressive tone map to maximize the channel utilization). In the first communication channel 212, data 214 is transmitted using higher order modulation and coding schemes. In FIG. 2, the first tone map utilizes a more “aggressive” physical layer throughput capability for physical layer transmission properties. The aggressive physical layer throughput may require higher orders of modulation, less error correction, or other settings which are intended to maximize transmission of data over the first communication channel 212.

A second example 222 is configured with a second tone map (such as a conservative tone map to maximize the channel reliability). The second tone map may have a lower physical layer throughput (including a smaller physical layer minimum transmission unit). In other words, the second tone map is less aggressive than the first tone map of the first example 212. However, communications may be more reliable than the first example 212 in the second tone map. Additionally, the second tone map may have a lower error rate while still conveying sufficient amounts of upper layer data 224 associated with a packet stream.

It should be understood that the second tone map may utilize the same number of carriers and same frequencies as offered in the first tone map. Other physical layer transmission properties may be modified, such as a modulation and coding scheme, guard spacing, cyclic prefixing, error coding, data replication, etc.

FIG. 3 is a table 300 illustrating hypothetical comparisons of two different tone maps. Properties and calculations associated with a first example tone map are shown in a first column 330. Properties and calculations associated with a second example tone map are shown in a second column 340. In the interest of illustrating a simple comparison, several basic properties are kept consistent. In fact, the only physical layer transmission property different from the first example tone map to the second example tone map is the modulation scheme. Thus, consistent properties of the communication channel include the use of 2690 usable carriers in the communications channel, a common 16/21 forward error correction (FEC) scheme, and a fixed symbol duration (such as 46.52 μs in this example). For example, a powerline communications network may be associated with a symbol duration of 46.52 μs. The symbol duration (46.52 μs) may be based on an orthogonal frequency division multiplexing (OFDM) symbol (e.g. 3072 FFT points at 75 MHz=40.96 μs) plus a guard interval (5.56 μs guard interval). In both example tone maps, a forward error correction technique is being used in which 16 bits of data and 5 bits of error correction are sent, resulting in 16/21 ratio of data for transmissions.

In the first example tone map, the tone map utilizes QAM-1024 modulation scheme (which conveys 10 bits of data per symbol on each carrier). In the first example tone map, the base tone map physical transmission rate would be 440.5683 mbps (2690 carriers×10 bits per symbol×16/21 FEC/46.52 μs). The first example tone map may be considered an aggressive tone map compared to the second example tone map. The first example tone map may be associated with lower latency, but may also have a higher probability for symbol errors due to the higher order modulation and coding scheme. Therefore, in one embodiment, the first example tone map may be well suited for UDP traffic.

In the second example tone map, the tone map utilizes QAM-16 modulation scheme (which conveys 4 bits per symbol on each carrier). For this example, all other physical layer transmission properties remain the same from the previous example. Using 2690 carriers×4 bits per symbol×16/21 FEC/46.52 μs, the tone map has a physical layer throughput capability of 176.2273 mbps. The second example tone map may be considered a conservative tone map compared to the first example tone map. The second example tone map may be associated with higher latency, but may also have a lower probability for symbol errors due to the lower order modulation and coding scheme. Therefore, in one embodiment, the second example tone map may be well suited for TCP traffic.

It should be apparent that the second tone map is more reliable than the first tone map because there is less probability of modulation symbol decoding errors when using QAM-16 than when using QAM-1024. The likelihood of modulation symbol errors is reduced because the constellation points are more widely spaced in QAM-16 than in QAM-1024.

In the examples in FIG. 3, only the modulation scheme was modified. However, other physical layer transmission properties may also be adapted. For example a case might be to utilize a lower code rate for the conservative tone map. Another approach could be to determine a new full tone map based on the original tone map and the new desired physical transmission rate (determined from the type of data to be sent). A new full tone map may have different transmission properties for the various carriers in the communication channel (keeping the receiver-generated tone map as maximum values).

In the case of powerline communications, changing the tone map currently requires an exchange of channel adaptation information from the receiver to the transmitter. However, the tone map can include a significant amount of transmission properties. Consider, for example, a communications channel capable of 1200 carriers. Transmitting a tone map for the communications channel may consume a large amount of channel overhead. Therefore, it may not be practical for the transmitting device to negotiate a tone map for each transmission. However, in accordance with some implementations, a transmitting device may adjust an existing tone map based on the type of data to transmit. An indication from the transmitter device may be sent in coordination with the physical layer transmission such that the receiving device may derive the adapted tone map without having a full exchange of channel adaptation information.

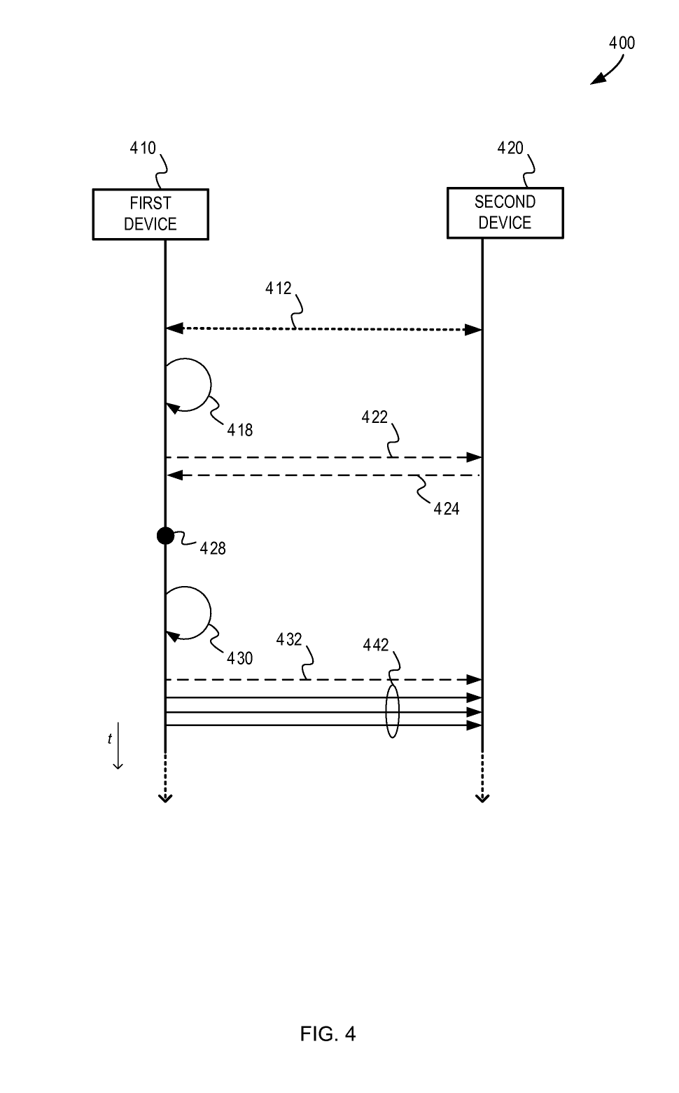

FIG. 4 is a message flow diagram illustrating an embodiment of the present disclosure. A first device 410 may be configured to communicate with a second device 420 over a communication channel (not shown). Beginning at 412, a first channel estimation process may be performed. This may include the first device 410 transmitting a training sequence, markers, or other measurement transmissions and the receiving device 420 utilizing the received training sequence, markers, or measurement transmissions to determine channel quality. The second device 420 may provide a receiver-generated tone map back to the first device 410 for use in subsequent communications. At 418, the first device may configure the network interface to use the receiver-generated tone map. At 422 and 424, one or more other configuration messages may be exchanged between the first device 410 and second device 420. For example, configuration messages may include other predefined tone maps, scheduling information, network topology information, etc.

At 428, the first device 410 determines that it has a packet stream to transmit to the second device 420. At 430, the first device 410 determines an adapted tone map based, in one embodiment at least in part, upon characteristics of the packet stream. The adapted tone map may also or otherwise be based in part upon the receiver-generated tone map (e.g. for increasing values of physical layer transmission properties, or for determining an adjustment factor that can be applied to down-step various properties of the receiver-generated tone map).

At 432, the first device 410 may communicate an indication to the second device 420 to indicate that an adapted tone map will be used. For example, the first device 410 may communicate a signal indicative of an adjustment factor or adaptation algorithm used to generate the adapted tone map from the first tone map. In one embodiment, the signal may be communicated in a frame control portion of a physical layer transmission unit.

At 442, the first device 410 may communicate the data to the second device 420. It should be understood that the adapted tone map may be reused for additional communications from the first device 410 to the second device 420. For example, the adapted tone-map may be used for a plurality of messages sent from the first device 410 to the second device 420.

FIG. 5 is a flow diagram illustrating example operations for determining adapted physical layer transmission properties based upon characteristics of a packet stream. The example operations may be performed by one or more components of a device, such as a physical layer controller, one or more communication unit processors, or one or more processors of a hybrid device. At 510, if the packet stream originated from upper layers of the device, there may be packet stream properties indicated by upper layers of a protocol stack that includes the physical layer. If so, then at 522, the device may inspect the packet stream properties. It should be understood that a packet stream may not be originated from a local device, and may be received via an ingress interface for forwarding to an egress interface. If there are no packet stream properties indicated by upper layers, then at 520, the device inspects at least one packet from the packet stream to gather characteristics for the at least one packet (e.g., the transport protocol being UDP or TCP).

At 530, the device determines the characteristics of the packet stream based upon the characteristics of at least one packet of the packet stream 520 and/or the packet stream properties provided by upper layers 522. At 542, a decision is made based upon the characteristics of the packet stream. If the packet stream is associated with a first characteristic (e.g. UDP), then the process continues to an optional decision at 546. At 546, if implemented, the device may determine if the amount of data to send is more than a minimum transmission size that would be associated with an aggressive tone map. If so, then at 565, the aggressive tone map is selected. It should be understood that if decision 546 is not implemented, then decision 542 would directly result in the selection of the aggressive tone map for the first characteristic (e.g., UDP). In some implementations, in which the adapted tone map is transmitter-generated, the aggressive tone map may also be adjusted based upon the amount of data. At 542, if the UDP traffic is very small, then it may be preferable to use a conservative tone map at 555 to avoid excessive padding that would otherwise be associated with a minimum transmission size.

Returning to the decision at 542, if the packet stream is associated with a second characteristic (e.g. TCP), then the process continues to an optional decision at 544. At 544, if implemented, the process may consider whether the receiver has limited or excess receiver buffer availability. If there is excess receive buffer availability, the adapted tone map may use an aggressive tone map at 565 even though the traffic type is TCP. If optional decision 544 is not implemented or if the receive buffer availability is limited, then the process continues to 555, in which a conservative tone map is selected.

It should be understood that considerations of the receive buffer availability and physical layer minimum transmission size are optional features in addition to the determination of physical layer transmission properties based at least in part upon the characteristics of the packet stream.

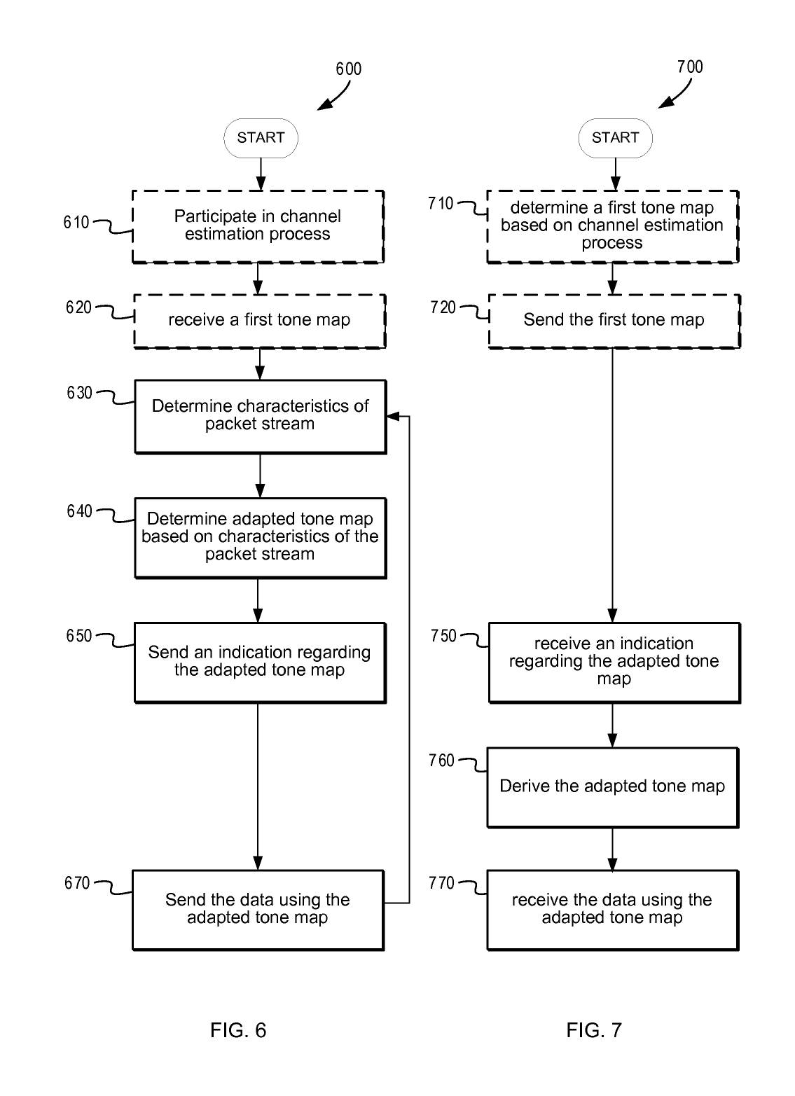

FIG. 6 is a flow diagram 600 illustrating example operations at a first device for adjusting physical layer transmission properties. At 610, the first device may participate in a channel estimation process. At 620, the first device receives a tone map from the second device. At some point, the first device obtains a packet stream to be transmitted to the second device.

At 630, the first device analyzes a transmit buffer to determine characteristics of the packet stream. Just as in FIG. 5, the packet stream may be obtained from upper layers of the first device or may be associated with a packet stream being forwarded via the first device. Example characteristics may include, for example, a transport protocol (e.g. TCP or UDP) associated with packets of the packet stream. At 640, the first device determines an adapted tone map based at least in part upon the characteristics of the packet stream. For example, the adapted tone map may be determined using example operations described in FIGS. 1-5.

At 650, the first device may send an indication regarding the adapted tone map. For example, the first device may signal, in a frame control symbol (FCS), a code representing an adaptation algorithm. By using a small code point in the FCS, the transmitting device may indicate that an adapted tone maps is utilized without adding significant overhead to existing protocols. In some embodiments, the transmitting device may simply indicate an adjustment factor and/or the adaptation algorithm employed. In some embodiments, an adaptation index may be used to reference a previously exchanged tone map or to reference a predefined adapted tone map known to both the first device and the second device.

At 670, the first device sends the data using the adapted tone map. In some implementations, the first device may repeat the operations at blocks 630-670 if there is additional data (e.g. further packet streams) in the transmit buffer.

FIG. 7 is a flow diagram 700 illustrating example operations at a second device for receiving transmissions with adapted physical layer transmission properties. At 710, the second device may participate in a channel estimation process and determine a first tone map based on the channel estimation process. At 750, the second device may receive an indication regarding the adapted tone map.

At 760, the second device may derive the adapted tone map based upon the indication and the previous first tone map. For example, the indication may comprise an adjustment factor that the second device can use to derive the adapted tone map. Alternatively, a code point, index, indication regarding an adaptation algorithm or other information may be included in the indication such that the second device may derive the adapted tone map.

By having the first device and second device employ the same adaptation algorithm, the first device may indicate an adapted tone map without communicating a full or partial tone map. For example, a signal from the first device to the second device could indicate an adjustment factor or adaptation algorithm being applied to adjust the offered tone map. This signal could be included, in one example, as part of a physical layer transmission unit header, or as an overhead signal. Rather than sending a new full tone map for each transmission, the first device could include some bits (e.g. in a frame control symbol of the physical layer transmission unit) that indicate how the tone map has been adjusted. The bits could represent an adjustment factor, changes in the modulation, error correction technique, or coding rate. The second device would use this information, along with the current tone map, to calculate a unique tone map for this packet. It should be understood that the adaptation algorithm could be implemented in hardware or software. At 770, the second device receives the data using the adapted tone map.

It should be understood that FIGS. 1-7 and the operations described herein are examples meant to aid in understanding embodiments and should not be used to limit embodiments or limit scope of the claims. Embodiments may perform additional operations, fewer operations, operations in a different order, operations in parallel, and some operations differently.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

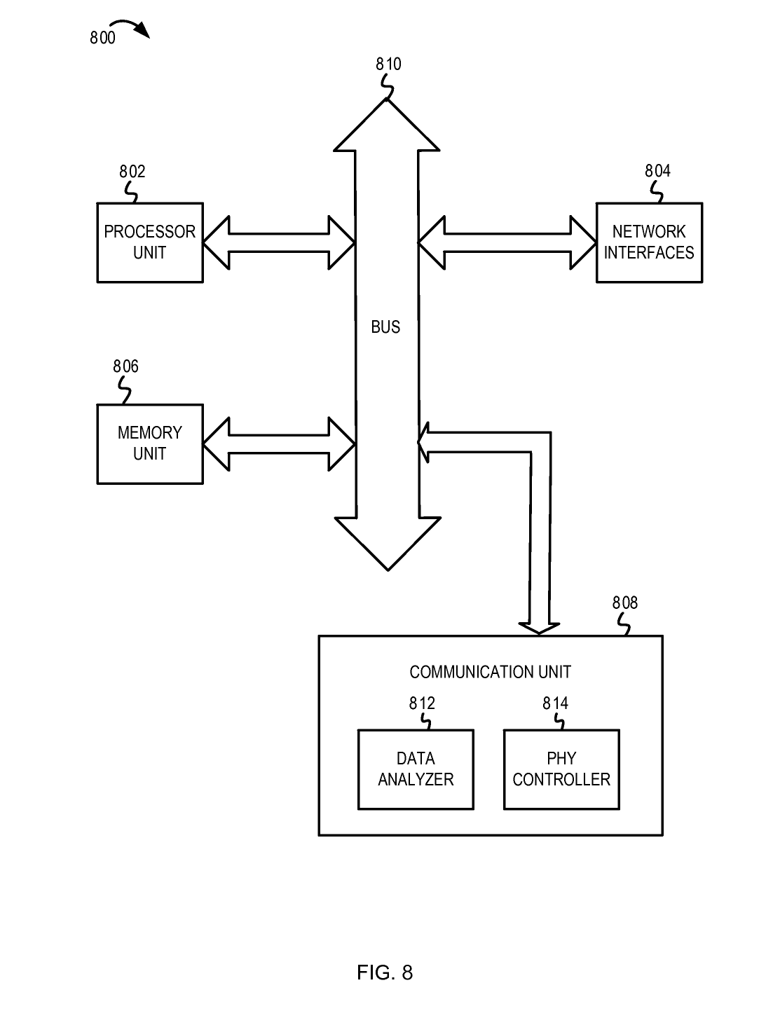

FIG. 8 is an example block diagram of one embodiment of an electronic device 800 including a communication unit capable of transmitting or receiving using adapted physical layer transmission properties based upon characteristics of a packet stream. In some implementations, the electronic device 800 may be one of a laptop computer, a netbook, a mobile phone, a powerline communication device, a personal digital assistant (PDA), or other electronic systems comprising a hybrid communication unit configured to exchange communications across multiple communication networks (which form the hybrid communication network). The electronic device 800 may include a processor unit 802 (possibly including multiple processors, multiple cores, multiple nodes, and/or implementing multi-threading, etc.). The electronic device 800 may include a memory unit 806. The memory unit 806 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 800 may also include a bus 810 (e.g., PCI, ISA, PCI-Express, HyperTransport®, InfiniBand®, NuBus, AHB, AXI, etc.), and network interfaces 804 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, the electronic device 800 may support multiple network interfaces—each of which is configured to couple the electronic device 800 to a different communication network.

The electronic device 800 also includes a communication unit 808. The communication unit 808 comprises a data analyzer 812 and a physical layer controller 814. As described above in FIGS. 1-7, the physical layer controller 814 may implement functionality to determine an adapted tone map and configure the network interface 804 with adapted physical layer transmission properties of the adapted tone map. It should be understood, that in some embodiments, the communication unit 808 may also have a dedicated processor (e.g., such as a communication unit comprising a system on a chip, or board with multiple chips, or multiple boards, in which the communication may have one or more dedicated processor or processing unit(s), in addition to the main processor 802). Any one of these functionalities may be partially (or entirely) implemented in hardware and/or on the processor unit 802. For example, the functionality may be implemented with an application specific integrated circuit, in logic implemented in the processor unit 802, in a co-processor on a peripheral device or card, etc. Further, realizations may include fewer or additional components not illustrated in FIG. 8 (e.g., video cards, audio cards, additional network interfaces, peripheral devices, etc.). The processor unit 802, the memory unit 806, and the network interfaces 806 are coupled to the bus 810. Although illustrated as being coupled to the bus 810, the memory unit 806 may be coupled to the processor unit 802.

While the embodiments are described with reference to various implementations and exploitations, it will be understood that these embodiments are illustrative and that the scope of the inventive subject matter is not limited to them. In general, adapted physical layer transmission properties as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a first hybrid device, characteristics of a packet stream to be transmitted from the first hybrid device to a second hybrid device via a communications channel of a hybrid network;
determining an adapted tone map for the communications channel based at least in part upon the characteristics of the packet stream,
wherein the adapted tone map is a first tone map if the characteristics of the packet stream include a first characteristic that the packet stream is associated with Uniform Datagram Protocol (UDP), and
wherein the adapted tone map is a second tone map if the characteristics of the packet stream include a second characteristic that the packet stream is associated with Transport Control Protocol (TCP), the second tone map having a slower physical throughput than the first tone map; and
transmitting at least one packet of the packet stream from the first hybrid device to the second hybrid device using the adapted tone map.

2. The method of claim 1, wherein the first tone map is an aggressive tone map relative to the second tone map, and the second tone map is a conservative tone map relative to the first tone map.

3. The method of claim 1, wherein the first tone map is associated with an offered tone map provided by the second hybrid device.

4. The method of claim 3, wherein the second tone map is based upon an adjustment factor applied to the offered tone map.

5. The method of claim 1, further comprising:
communicating an indication regarding the adapted tone map from the first hybrid device to the second hybrid device prior to said transmitting.

6. The method of claim 1, wherein the adapted tone map is adjusted dynamically if the characteristics of the packet stream include both the first characteristic that the packet stream is associated with UDP and the second characteristic that the packet stream is associated with TCP.

7. The method of claim 1, further comprising:
for a second packet stream to be transmitted from the first hybrid device to the second hybrid device:
determining, at the first hybrid device, characteristics of the second packet stream;
determining a second adapted tone map based at least in part upon the characteristics of the second packet stream; and
transmitting at least one packet of the second packet stream from the first hybrid device to the second hybrid device using the second adapted tone map.

8. A communication system comprising:
a transmitting device coupled to a communications channel between the transmitting device and a receiving device, the transmitting device configured to:
for at least a first packet of a packet stream to be transmitted from the transmitting device to the receiving device, determine physical layer transmission properties for the communications channel based at least in part upon an upper layer protocol field included in the first packet, and
transmit the first packet of the packet stream to the receiving device using the determined physical layer transmission properties; and
the receiving device coupled to the communications channel, the receiving device configured to receive the first packet of the packet stream using the determined physical layer transmission properties.

9. The communication system of claim 8, wherein the communications channel includes a powerline communications channel and the physical layer transmission properties comprise a physical layer tone map.

10. The communication system of claim 8,
wherein the transmitting device is further configured to communicate an indication regarding the determined physical layer transmission properties to the receiving device; and
wherein the receiving device is further configured to receive the indication and derive the determined physical layer transmission properties based upon the indication.

11. A method comprising:
for at least a first packet of a packet stream to be transmitted from a first device to a second device via a hybrid network:
determining, at the first device, a physical layer tone map for a communications channel of the hybrid network, the physical layer tone map based at least in part upon an upper layer protocol field included in the first packet; and
transmitting at least the first packet of the packet stream to the second device using the determined physical layer tone map.

12. The method of claim 11, wherein said determining the physical layer tone map includes:
for a first type of data, setting the physical layer tone map to a first physical layer (PHY) transmission rate that has lower latency than a second PHY transmission rate, and
for a second type of data, setting the physical layer transmission properties to the second PHY transmission rate.

13. The method of claim 12, wherein the first type of data includes Uniform Datagram Protocol (UDP) traffic, and the second type of data includes Transport Control Protocol (TCP) traffic.

14. The method of claim 11, wherein said determining the physical layer tone map includes determining a transmitter-selected tone map for use over the communications channel between the first device and the second device, the transmitter-selected tone map including physical layer transmission properties for each of a set of frequencies.

15. The method of claim 14, wherein the transmitter-selected tone map is different from a receiver-provided tone map having a higher transmission speed previously determined based upon a channel estimation process compared to the transmitter-selected tone map.

16. The method of claim 15, wherein, for a first type of data, the transmitter-selected tone map utilizes a smaller modulation scheme for at least one frequency than the receiver-provided tone map.

17. The method of claim 14, further comprising:
communicating a signal indicative of the transmitter-selected tone map to the destination device.

18. The method of claim 17, wherein the signal is communicated in a frame control portion of a physical layer transmission unit.

19. The method of claim 17, wherein the signal includes an adjustment factor indicating that the transmitter-selected tone map is derived based upon the adjustment factor and the receiver-selected tone map.

20. The method of claim 11, wherein said determining includes determining the physical layer tone map at medium access control (MAC) layer of the first device.

21. The method of claim 11, wherein said physical layer tone map includes, for each of a set of frequencies used on the communication channel, one or more of a modulation scheme, forward error correction scheme, coding rate, or guard interval.

22. The method of claim 11, wherein said determining includes:
sending to the second device, an indication of the type of data associated with the packet stream, and
receiving a the physical layer tone map from the second device, the physical layer tone map based at least in part upon a channel estimation process and the type of data associated with the packet stream.

23. A first device comprising:
a physical layer controller configured to, for at least a first packet of a packet stream to be transmitted from the first device to a second device via a hybrid network, determine a physical layer tone map for a communications channel of the hybrid network, the physical layer tone map based at least in part upon an upper layer protocol field included in the first packet; and
a network interface configured to transmit at least the first packet of the packet stream to the second device using the determined physical layer tone map.

24. The first device of claim 23, wherein,
for a first type of data, the physical layer tone map is associated with a first physical layer (PHY) transmission rate that has lower latency and less reliability than a second PHY transmission rate, and
for a second type of data, the physical layer transmission properties are associated with the second PHY transmission level.

25. The first device of claim 24, wherein the first type of data includes Uniform Datagram Protocol (UDP) traffic and the second type of data includes Transport Control Protocol (TCP) traffic.

26. The first device of claim 23, wherein the physical layer controller is further configure to:
cause the network interface to communicate a signal indicative of determined physical layer tone map to the second device prior to transmitting at least the first packet of the packet stream.

27. The first device of claim 26, wherein the signal is communicated in a frame control portion of a physical layer transmission unit.

28. The first device of claim 26, wherein the signal includes an adjustment factor indicating that the physical layer tone map is derived based upon the adjustment factor and a previously exchanged tone map.

29. A method comprising:
receiving, from a first device at a second device, first packets associated with a first portion of a packet stream, the first packets received using a first set of physical layer transmission properties;
determining, at the second device, a second set of physical layer transmission properties for use with subsequent packets of the packet stream, the physical layer transmission properties based, at least in part, upon a type of data in the first packets;
communicating the second set of physical layer transmission properties to the first device; and
receiving second packets associated with a second portion the packet stream using the second set of physical layer transmission properties.

30. The method of claim 29, wherein the second set of physical layer transmission properties is also based at least in part upon an amount of receive buffer available at the second device.

31. The method of claim 29, wherein said communicating the second set of physical layer transmission properties comprises communicating an adjustment factor that is usable with the first set of physical layer transmission properties to derive the second set of transmission properties.

32. The method of claim 29, wherein the packet stream includes a mix of Transport Control Protocol (TCP) and Uniform Datagram Protocol (UDP) packets.

33. A non-transitory computer readable medium storing computer program code, the computer program code comprising instructions which when executed by a processor of a hybrid device cause the hybrid device to:
for at least a first packet of a packet stream to be transmitted from a first device to a second device via a hybrid network:
determine, at the first device, a physical layer tone map for a communications channel of the hybrid network, the physical layer tone map based at least in part upon an upper layer protocol field included in the first packet; and
transmit at least the first packet of the packet stream to the second device using the determined physical layer tone map.

34. The non-transitory computer readable medium of claim 33, wherein said computer program code further comprise instructions which when executed by a processor of a hybrid device cause the hybrid device to:
for a first type of data, set the physical layer tone map to a first physical layer (PHY) transmission rate that has lower latency and less reliability than a second PHY transmission rate, and
for a second type of data, set the physical layer transmission properties to the second PHY transmission rate.

35. The non-transitory computer readable medium of claim 33, wherein the first type of data includes Uniform Datagram Protocol (UDP) traffic, and the second type of data includes Transport Control Protocol (TCP) traffic.
